(19) United States
(12) Patent Application Publication
(10) Pub. No.: US 2011/0289880 A1
(43) Pub. Date: Dec. 1, 2011

(54) Real Time On Demand Internet Dispatch Queue

(76) Inventor: John Burdin, Tulsa, OK (US)

(21) Appl. No.: 12/790,822

(22) Filed: May 29, 2010

(51) Int. Cl. E04B 1/00; G06Q 50/00; G06Q 30/00; G06Q 10/00

(52) U.S. Cl. 52/747.11; 705/80; 705/26.1

(57) ABSTRACT

A method for self dispatching services of tradesmen or other service providers. The invention allows consumers to order services in a real time environment. The present invention allows consumers to find contractors that are available for hire during the customer search in real time atmosphere. The invention allows contractors to join the queue whenever they are available for hire.

Contractors will increase productivity by using an online queue that takes advantage of time loss due to missed appointments and gaps in work schedule. By simply joining the queue they will be in a real time on demand service queue with other locals waiting for employment from customers.

Customers will increase productivity by using the online queue because now services will be available at time of search removing the need for future scheduling and series of other common delays that cost the customers time.

### BACK GROUND OF THE INVENTION

1. Field of the Invention

¹The present invention relates to a method for self dispatching service of trade persons or other service providers such as plumbers, electricians, roofers ect. The present invention allows consumers to order services based on available on demand contractors that are waiting for work. The customer can select a trade, view all available contractors and choose from a list selecting a contractor that can immediately provide service to the customer. ¹ 05/29/2010 John Burdin #87954 Real Time On Demand Internet Dispatch Queue

The present invention allows contractors easy access to additional customers by easily allowing contractors to toggle on and off availability. This allows contractors an avenue to create extra work in gaps in their work day or after unexpected cancellations. Contractors bid for placement on the queue and can offer brief description that can be viewed by customer. Once contractor has work they just toggle off.

2. Description of the Related Art

Currently, there is not a way for customers to view all available contactors in their service area all grouped together in a real time queue. There are no queues that allow contractor without work to reach out to the public and advertise availability in real time.

The present invention addresses this need by allowing contractors an easy toggle that can be accessed by internet, text, and by phone. Contractors simply create an account and set contractor preferences. Contractors can utilize invention to fill revenue gaps in their work day while offering a convenient service to the marketplace.

### SUMMARY OF THE INVENTION

The present invention is an internet based method for self dispatching services of tradesmen or other service providers such as plumbers, electricians, HVAC serviceperson, ect. This vendor based dispatching method employs a social internet queue system that allows service providers a real time market place to advertise immediate availability. Contractors create an account add contact information and services they offer and their service area by city and zip code. They bid for queue placement and pay when customers access their contact information. A simple toggle allows the contractor to turn “on” and “off” this feature.

The present invention allows customers a social queue system to find real time available contractors that are available for immediate dispatch to the customer.

### DETAILED DESCRIPTION OF THE PREFERRED EMBODIMENT

Referring now to the drawings and initially to FIG. 1-2, there are shown flow charts that detail the present invention which is an internet based method for self dispatching on demand real time service professionals for immediate dispatch. The method consist of two distinct subsections or portions: A customer process portion and a vendor process portion.

Referring now to FIG. 1, the customer process portion of the method starts at box 100 and moves to box 110. In box 110 customer enters the site, the first screen the customer will see will look similar to FIG. 3. In box 120 the customer can select the type of service required that will be in distinct categories, plumbing, electrical, roofing ect. As shown in FIG. 3 box 300. Then customer will then enter zip code of property to be serviced shown as box 310 in FIG. 3 which will then display current providers that are available for immediate dispatch shown in FIG. 3 box 320 moving customer to box 130 in FIG. 1. Customer will now see all vendors that are available for immediate dispatch to the service zip code provided. Moving to FIG. 1 box 140 the customer clicks boxes to retrieve contact information of desired contractors, this is shown in FIG. 3 box 330. The customer makes contact with vendor which dispatches immediately to customers address moving the customer process to box 150 and then ending the customer process in FIG. 1 Box 160 ²Although not specifically described in the scope of the invention. The customer will be able to view brief info about contractors and flag vendors that are not available or not responding. Furthermore other options that do not impact the spirit of the scope of the mentioned invention can further enhance customer experience. These unmentioned features are feedback, property history and vendor profiles. ² 05/29/2010 John Burdin #87954 Real Time On Demand Internet Dispatch Queue

Referring now to FIG. 2, the vendor/contractor process portion of the method starts at box 200 and moves to box 202. Vendor enters site, the first screen they see is similar to FIG. 3. Vendors new to the service will need to create an account. Vendors navigate to FIG. 3 box 340 which moves them to FIG. 2 box 204. Box 204 will be an explanation with how the invention works. The vendor will have to agree to terms to move to box 206. Upon agreeing to terms vendor moves to box 206, box 206 is a computer screen similar to FIG. 4. Here the vendor can add the services they offer and the areas they work in. The queue system will then ask vendors to provide the bid they wish to pay per each click. The vendor will be required to register billing information if they bid above one cent. Bidding more will place vendors in front of the queue line. Bidding less moves them down the list. The lowest bids are in line by the order they joined the queue. Completing the bid process moves vendor to box 210 which ends the vendor creation process and moves vendor to box 212.

FIG. 2 box 212 starts the process of vendors with accounts. Vendors are required to login into their password protected accounts. This moves the contractor to box 214. In box 214 the vendor toggles their availability in a real time internet atmosphere. This toggle starts ³in the off position and requires contractor to turn it on and confirm they are available. This toggle can be accessed by internet, phone, and text messaging allowing vendors ease of use and insuring the ability to turn it off when they are no longer available. Vendors turn the toggle on and wait for new work. When vendors are no longer available they move to box 218. Box 218 includes other jobs, lunch breaks and any other things that come up that makes contractor unavailable. Moving to box 220 of FIG. 2 the vendor logs into queue system and removes themselves from the queue. Which moves vendor to box 222. This ends the vendor portion. ^{3 3} 05/29/2010 John Burdin #87954 Real Time On Demand Internet Dispatch Queue

Although not specifically described in the scope of the invention. The vendor will have reminders they can set to make sure they do not forget turning off the queue. Also this is just one way to utilize a real time vendor queue and request patent protection to protect the spirit of the invention. Which is allowing vendors with openings to queue in a line and letting the customer have a marketplace of real time available vendors.

### BRIEF DESCRIPTION OF THE DRAWINGS

FIG. 1 is a flow chart showing a customer process of a self dispatching method for services according to a preferred embodiment of the present invention.

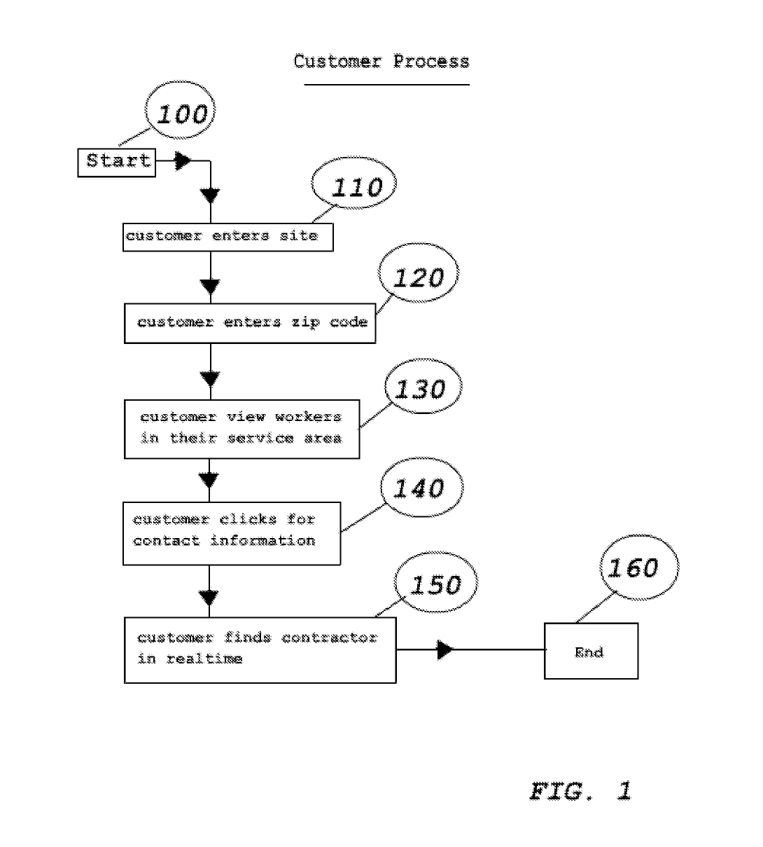

FIG. 2 is a flow chart showing a vendor process portion of a self dispatching method of services according to a preferred embodiment of the present invention.

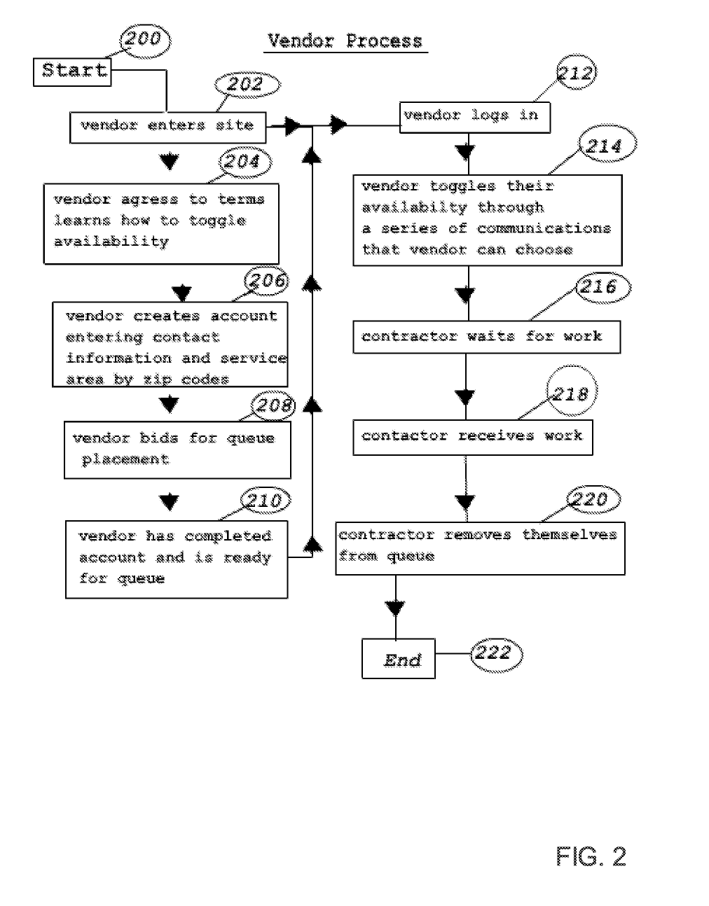

FIG. 3 is a computer screen showing the customer panel where the customer can view available contractors by selecting service zip code and selecting desired services.

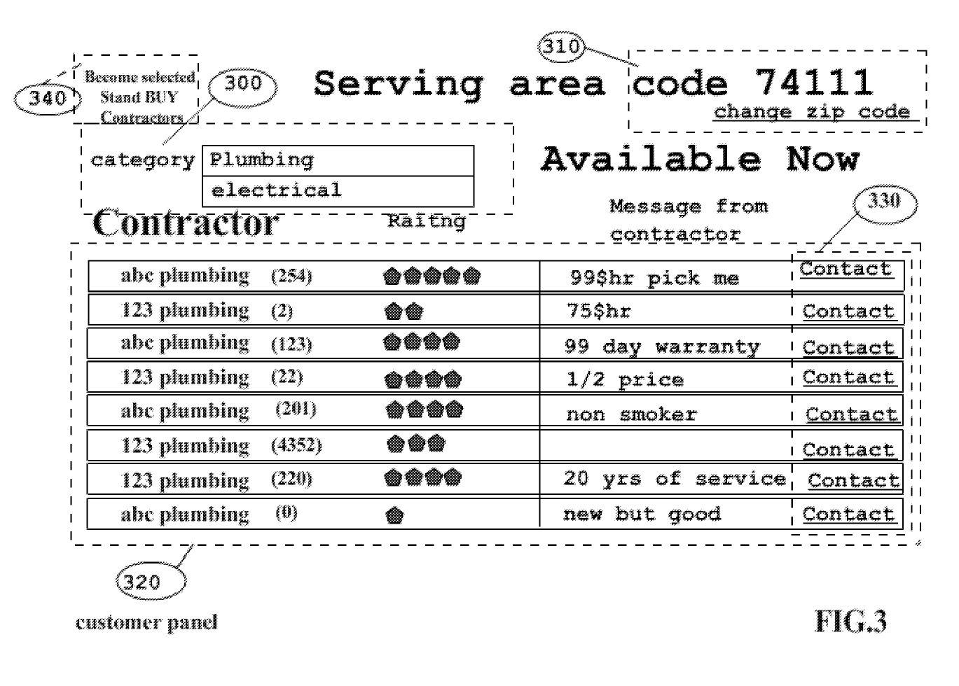

FIG. 4 is a computer screen showing the vendor panel. This panel is a dashboard for the contractor to enter information about company and select pricing for queue placement.

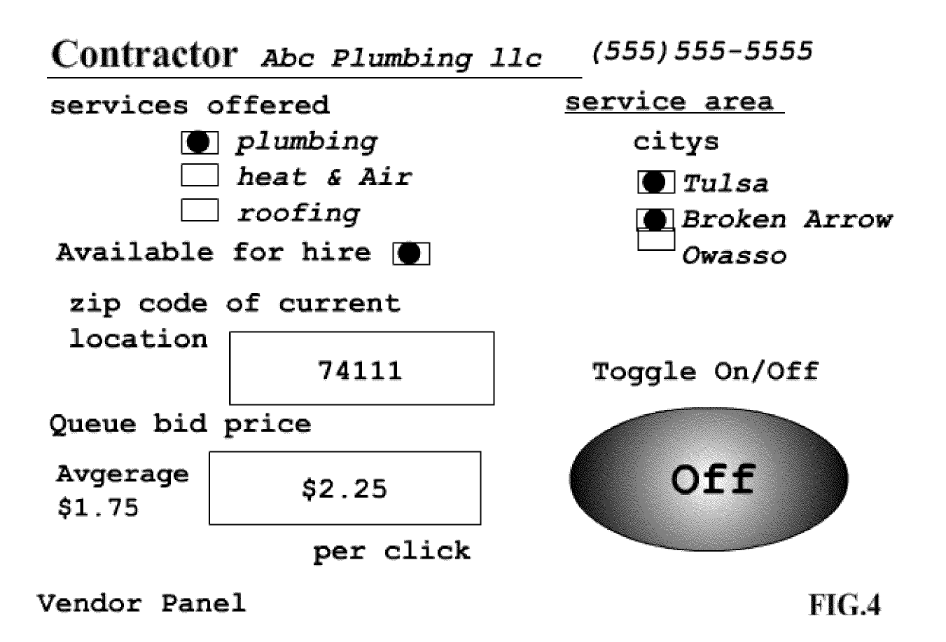

What is claimed:

1. A self dispatching method for services comprising of an on demand online service queue
A vendor process portion, where a vendor provides information on services and where mentioned services are available. Vendor toggles availability on and off in a real time queue using the internet.
A customer process portion, where the customer uses the internet to find available contractors in real time internet environment for immediate service.

2. A Self dispatching method for service according to claim 1, wherein the vendor process portion further encompasses
Creating a vendor profile in the system
Creating service area
Setting up account and setting bid amount

3. A self dispatching method for services according to claim 1
Where in the customer process portion further comprises logging into the system, entering the zip code for service and viewing a queue
clicking on contractors to show contact information
hiring contractor for immediate service
